(19) United States
(12) Patent Application Publication
(10) Pub. No.: US 2018/0130264 A1
(43) Pub. Date: May 10, 2018

(54) VIRTUAL REALITY EDITOR

(71) Applicant: ARNOOVO INC., Montreal (CA)

(72) Inventor: Sébastien EBACHER, Montreal (CA)

(21) Appl. No.: 15/803,776

(22) Filed: Nov. 4, 2017

Related U.S. Application Data
(60) Provisional application No. 62/417,680, filed on Nov. 4, 2016.

(51) Int. Cl. G06T 19/20; H04N 13/04; H04N 5/232; G06T 19/00

(52) U.S. Cl. CPC G06T 19/20; H04N 13/0445; G06F 3/04842; G06T 19/006; H04N 5/23238

(57) ABSTRACT

Provided is a system for editing in real-time immersive content. The system may comprise a tactile input device interface for receiving input in real-time from a tactile input device, an immersive display interface for transmitting in real-time content to display to an immersive display, a processing device in communication with the tactile input device interface and the immersive display interface, and a computer readable storage medium accessible by the processing device and comprising instructions for instructing the processing device to instantiate an editing software in real-time. The instructions may include directives to display the immersive content in an immersive mode using the immersive display, receive input representative of a modification to be performed in real-time on the immersive content from the tactile input device, and apply the modification to the immersive content in real-time.

### CROSS-REFERENCE

The present United States patent application claims priority from U.S. provisional application No. 62/417,680, filed Nov. 4, 2016, entitled VIRTUAL REALITY EDITOR. This document is enclosed herein by reference in its entirety.

### TECHNICAL FIELD

The current invention relates to the field of content editing, and more particularly of immersive content editing such as for panoramic content e.g. spherical images or image streams and stereoscopic panoramic content.

### BACKGROUND

In modern displays, the field of view may refer to the extent of an observable image displayable. For example, television displays commonly have a resolution of 4096×2160 pixels, meaning that an image of that size or less will fit in the field of view of the television display. Because, the screen size on traditional 2D displays hardware is limited to the physical size of the display. Since the viewer natural field of view is larger than the size of the traditional displays, they cannot allow total or partial, immersion like virtual reality (VR) displays that recreate or mimic a life size viewing experience. Virtual reality immersive experiences are created by putting the users inside a spherical images or videos of 360 degrees that are viewable by using a head mounted display (HDM) that tracked user's head movement in real-time allowing the synchronisation and alignment of user's head position and moving FOV position inside the spherical images or videos. Thus, by mimicking in the virtual reality the way we view our world as human beings, we put the virtual reality users in full immersion in a virtual environment and consequently, the users become virtually blind of his “real” surrounding environment. When a user is fully immersed, his capacity to interact with the “real” environment become greatly limited.

In the present context, panoramic images refer to images that go beyond the range of a planar display's field of view such that they cannot be presented on the display in their entirety without modification and distortion. Panoramic image in virtual reality also refer to a equirectangular image that represents a planar projection of a 360-degrees spherical image. Such panoramic images have become more common with the advent of panoramic and omnidirectional photography. Other sources of panoramic images include computer graphics (CGI) whereby wide field-of-view images may be generated. Panoramic images may be present as still images or as video images, typically made up of sequences of still images.

Panoramic images are typically curved images captured for display on a curved display. These can include domed-perspective images such as spherical or hemispherical images which are rounded to conform to a similarly rounded display such as a spherical or hemispherical display, as the case may be. Flattening curved or non-planar images for display on a flat non-panoramic display requires distortion.

Stereoscopic panoramic images include separate perspectives for the left and right eye of a viewer. Using stereoscopy to replicate the view of a scene from the perspective of different eyes is used to achieve depth perception of objects in the scene. Stereoscopic panoramic images include 360° spherical content, such as still images or video, and hemispherical images and the like.

Curved panoramic images are made to be viewed on a display providing a curved perspective. Although curved and even spherical or hemispherical displays exist, for 3D stereoscopic curved panoramic images are typically viewed on, and are made to be viewed on, an immersive virtual reality (VR) display. VR presents to the viewer the right imagery as they look around a curved panorama. Stereoscopic VR displays, like the Oculus Rift™ or phone-equipped Samsung Gear VR™ are typically head mounted stereoscopic displays that present respective portions of a stereoscopic panoramic image to each eye of the wearer. Typically, in order to provide a more distant point of focus, VR displays include lenses for each eye. These lenses may introduce a distortion which may be compensated in the image itself either at capture/generation or at the display. Head tracking hardware allows a processor to track head movement and/or position of the wearer and to adapt the portions displayed as a function of the head movement/position to create an immersive experience whereby a wearer can “look around” within the range of curvature of the stereoscopic panoramic image naturally.

Stereoscopic panoramic images, however, cannot be faithfully fully displayed on a traditional flat display. Panoramic images such as those captured by 360-degrees (omnidirectional) cameras, are typically made up of multiple sub-images that are stitched together. In some cases, the stitching may introduce artifacts or visual effects when viewed in immersion.

Stereoscopic panoramic image content is typically made for viewing with an immersive display. Immersive displays like stereoscopic VR displays provide an immersive experience. It is not possible to view the same content in the same manner on a monoscopic flat screen. Techniques for displaying panoramic images, such as spherical images, on a flat screen rely on distorting/modifying the image which alters the perspective. It is not possible to view the image with the same perspective and see the same elements. Moreover, where the flat screen is monoscopic, and the panoramic image stereoscopic, there is a loss of depth perception which prevents any appreciation of three-dimensional perspective. Thus, there is a big difference in the experience of viewing panoramic images on a flat screen (i.e. in a flat mode) as opposed to on an immersive display (i.e. in an immersive mode). All the details, perspectives and experiences perceivable in immersive mode cannot be appreciated when a panoramic image is viewed in a flat mode. Likewise, depth perspectives and the effect of editing thereon may not be appreciated when viewing an image monoscopically.

Nonetheless, current video post-production, assembly and editing technologies for panoramic videos, even stereoscopic ones, still heavily rely on flat-screen display. These tools and workflows have not been conceived and developed with virtual reality in mind and consequently suffer from many drawbacks for this application. Editors and content creators are forced to edit video outside of the immersive mode, which means that they cannot appreciate the full details and perspectives of the video as it will be viewed while they edit. The same is true for still images. With current technologies, editors have to rely on their imaginations and assumptions to mentally project themselves into the immersive experience to appreciate the full impact of their modifications. In the best scenario, they can move the image with their manipulating devices (e.g. mouse, keyboard, controller), to simulate the head movement. This poses significant limitations in ability and quality assurance in improving and editing panoramic content during production and post-production.

This situation is mainly caused by the fact that once in immersion, the users cannot use the traditional PC interface in order to access the editing tools because he is virtually blind. Right now, there is no editing solution that have be built with the immersion in mind, with interface and editing tool that are adapted for immersive input device and changes that are viewable in real-time directly in an immersive head mounted display for virtual reality, augmented-reality or other immersive displays.

### SUMMARY

Provided is a real-time rendering engine providing a solution for editing (up to) 360-degrees stereoscopic content in an immersive mode with a virtual reality headset, augmented reality headset or similar viewing device.

In accordance with a broad aspect is provided a system for editing immersive content in real time. The system may comprise a tactile input device interface for receiving input from a tactile input device, an immersive display interface for transmitting content to display to an immersive display, a processing device in communication with the tactile input device interface and the immersive display interface, and a computer readable storage medium accessible by the processing device and comprising instructions for instructing the processing device to instantiate an editing software. The instructions may include directives to display the immersive content in an immersive mode using the immersive display, receive input representative of a modification to be performed on the immersive content from the tactile input device, and apply the modification to the immersive content. The modification may include editing, color modifications such as color grading, visual effects, video effects, special effects, video transitions and audio effects.

### BRIEF DESCRIPTION OF THE DRAWINGS

The invention will be better understood by way of the following detailed description of embodiments of the invention with reference to the appended drawings, in which:

FIG. 1 is a conceptual illustration of the technological tools proposed herein according to a particular embodiment;

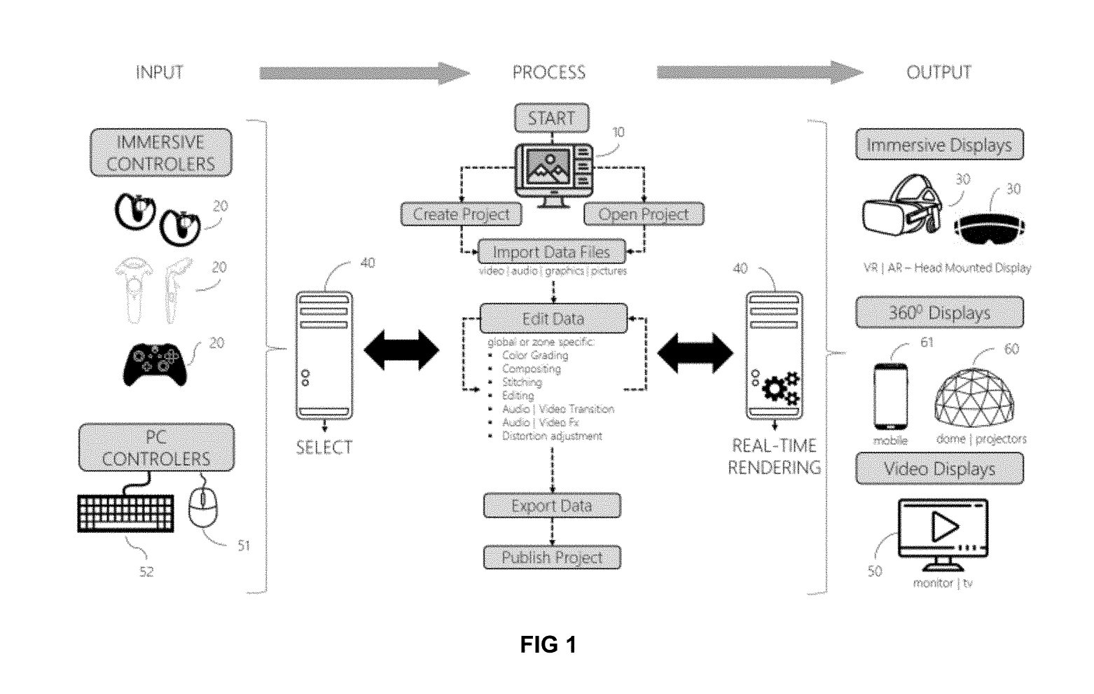

FIG. 2 shows the usable inputs device in a fully immersive environment;

FIG. 3 represents the two different iteration loops for immersive content creation and editing, the traditional one, on a PC and the new proposed one performed inside a immersive head mounted display;

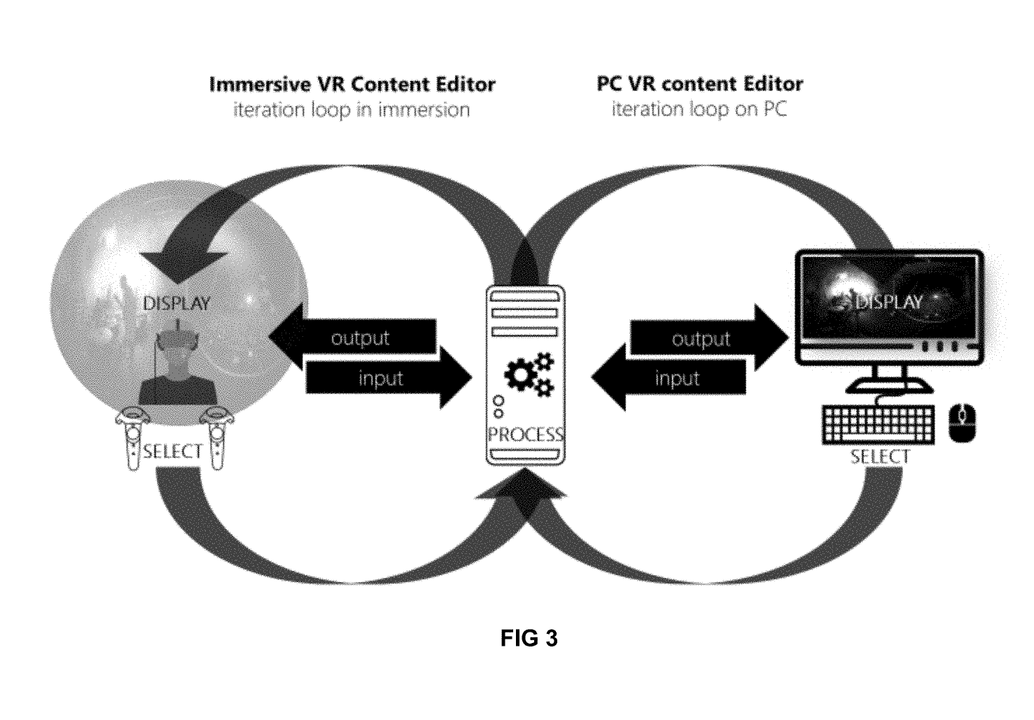

FIG. 4 shows the comparison and relation between a same image displayed as a spherical immersive content and as a flat immersive content;

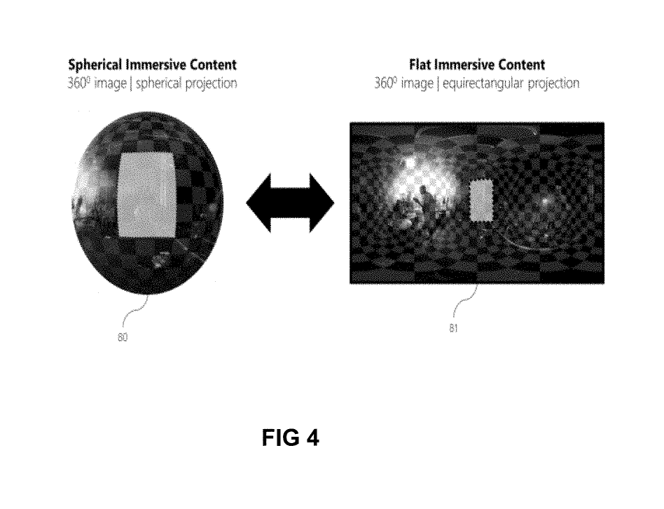

FIG. 5 shows the user's actual field of vision when immersed in virtual reality compared to entire visual content of the image viewable in virtual reality immersion; and

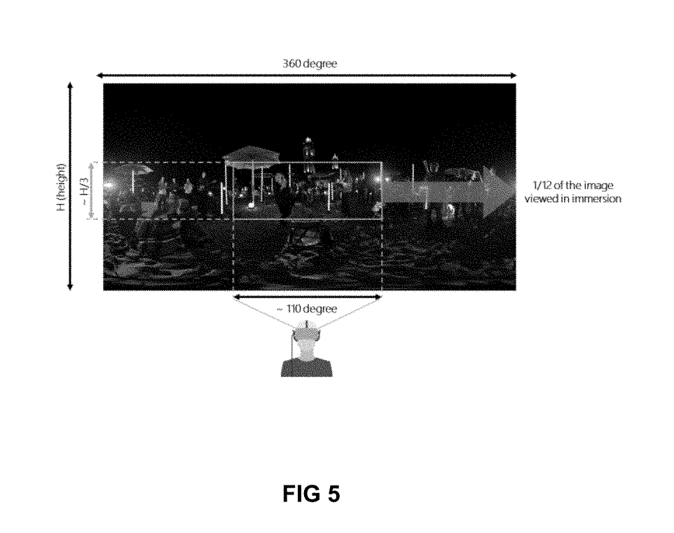

FIG. 6 shows the menu and zone selection tools in the proposed interface, showing the checkerboard zoning for the proposed zone selection solution, where choices made in the spherical image in immersion are reflected in an equirectangular projection of the same scene;

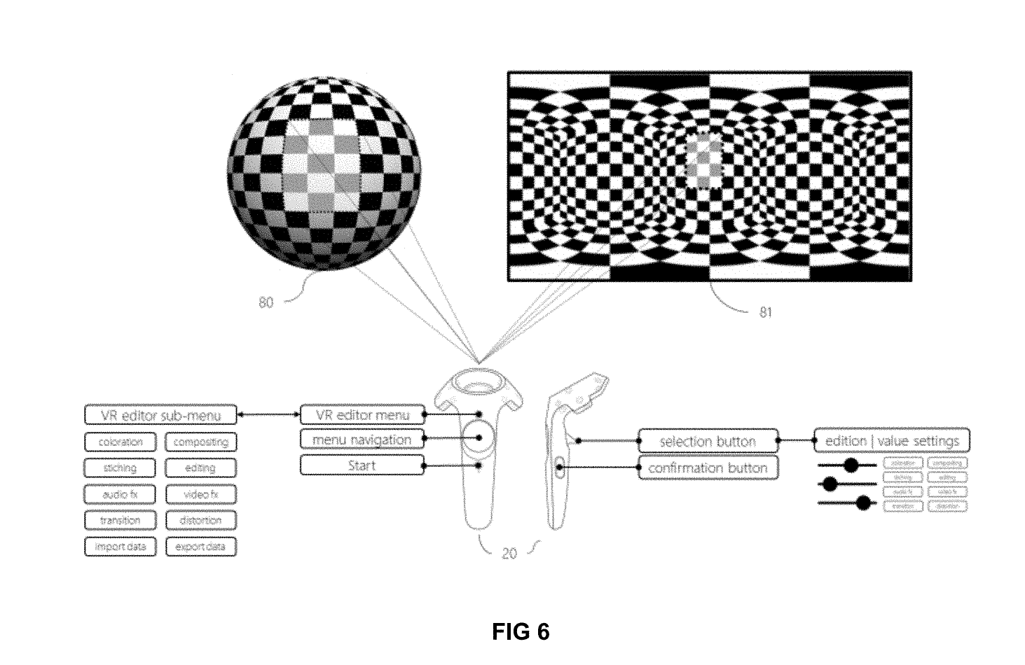

### DETAILED DESCRIPTION

Provided is technology for improved image editing for panoramic images such as spherical 360° video content or the like. The technology provided may be used in production and post-production video editing. In particular, the technology provided is suited for editing stereoscopic panoramic image content in an immersed virtual reality setting such that the full details and various perspectives of the content can be appreciated during the editing process and such that the impacts of editing choices on the immersive experience can be appreciated during editing.

To this end, a virtual production and post-production studio is proposed having a workflow, tools and user interface specifically adapted to the immersive viewing mode of virtual-reality content such as stereoscopic panoramic images. Provided is an editing software system 10, which may be tangibly stored on a computer-readable storage medium in the form of computer-executable programming instructions and related data. The editing software 10 may be controlled using a user-manipulable input device 20 connected to a control station computer (not shown) running the editing software 10. A VR headset 30 displays in immersive mode the content being edited by the editing software 10. Optionally, a connected planar display 50 may also display the content and editing tool in flat mode, however in the present example the editing software 10 may be used in immersive mode without resorting to the planar display 50 for editing. This system allows editing of content directly in the immersive mode with the proper perspectives.

With prior art post-production tools, we can easily select target regions of an image or stream of images by identifying it (e.g. rectangular zones on a planar surface). However, in virtual reality, images tend to be spherical or elliptic. The present system allows selection of irregular zones. In particular, it advantageously allows the correct identification and treatment of zones to transpose these onto a planar presentation, either on the optional planar display 50 or within the immersive experience. In the present example, user manipulations are received by the editing software 10 via an external controller, specifically in this example a HTC Vive controller, or an oculus touch and an Xbox controller.

The editing software 10 provides the ability to apply image treatment/processing to different segments or sections of a curved-display image or stream of images. Thereby the system advantageously allows differentiated treatment of different portions or perspectives of (an) image(s) such that different modifications, if any, are made to different portions. In a simple example, different contrast settings may be applied on one half of a spherical scene than on the other. This allows editors to work with and compensate for the realities of panoramic (and particularly 360°) capture, where light conditions and intensity may vary greatly from one angle to the next.

Polar coordinates could be used to identify portions of an image. In the polar coordinate, the reference point (analogous to the origin of a Cartesian system) is called the pole, and the ray from the pole in the reference direction is the polar axis. The distance from the pole is called the radial coordinate or radius, and the angle is called the angular coordinate, polar angle, or azimuth. Alternatively, spherical coordinates could be used to identify portions of an image. Spherical coordinates (r, θ, φ) as commonly used in physics (ISO convention): radial distance r, polar angle θ (theta), and azimuthal angle φ (phi). The symbol ρ (rho) is often used instead of r.

The editing software 10 may also provide the ability to magnify a portion of the panoramic image or to do sphere rotation through manual input to turn the image without physically turning the viewer's head (as in a head-tracking implementation) to reduce viewer's fatigue.

Thus, the system provides virtual reality content creators the first true solution to edit immersive content like stereoscopic panoramic images in the final viewing mode of the content in an immersive mode.

The editing software 10 provides for easy identification of zones to edit within the immersive mode and access to editing tools that can be used, e.g. on specifically identified zone or zones within the immersive mode (e.g. while using a virtual reality headset) thanks to its cooperation with a handheld tactile input device 20 that can be manipulated without seeing it, as is the case with game controller-type devices. As described, the editing software 10 thus allows editing in a curved (e.g. spherical) representation of a panoramic (e.g. spherical) image and can also be used for editing in planar display 50.

The advantages of the present system include the ability to see the correct view of the image being edited, where past systems required distortion to display it on a planar display 50 (with tools that are adapted for immersive experiences). Moreover, using the immersive mode the whole image may be appreciated and the depth as well, which provides the user with the ability to appreciate the full impact of the edits. In the non-immersed mode, it is not possible to get the full feeling of the immersion, and appreciate details such as where the attention gets focused, how the immersion (including possible lens effects) affects the perception and how an image's overall look is changed by the modifications performed (adaptation to make the VR editors capable of using editing tools to improve quality of the image for the immersive experience).

A user may easily use a virtual reality display 30 (typically a head-mounted display or HMD) to identify zones to edit and to do the treatment/processing of these zones within the virtual reality experience and display the new output with the changes in real-time. The editing software 10 may run on various devices, however in one example the control station is a desktop computer that is connected to both the virtual reality display 30 and a planar display 50 and outputs to the virtual reality display 30 the immersive content in immersive mode, with certain graphical user interface components optionally overlaid in the image. Alternatively, these components may be “intralaid” in that they are presented within the immersive experience but with a certain depth such that they may be occluded by image content lying closer than their depth. These components, the content itself (e.g. orientation) and other settings (e.g. that are not visually represented) may be manipulated with the input devices 20. In this example, the same editing software 10 simultaneously displays the immersive content in planar mode on the planar display 50 alongside the editing tools which may be user-manipulable with input devices 20 as is done with planar editing tools. This allows users more familiar with planar tools to revert to this form of editing if necessary. In one example, the system is used for live editing of immersive content by applying editing changes in real-time or near-real-rime to the content for broadcasting.

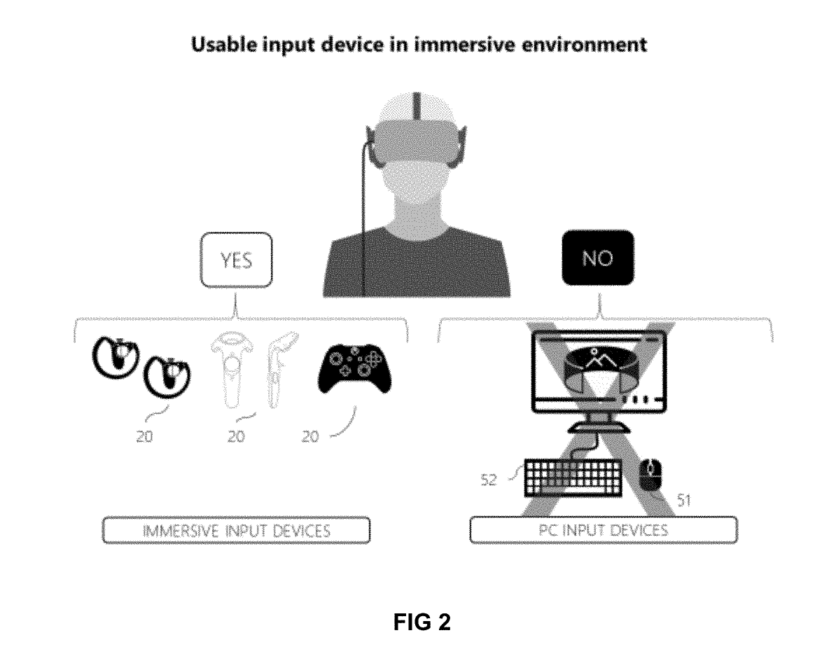

Edits may be performed by selecting applicable portions of a panoramic image. In one example a panoramic image being edited is divided logically into a checkerboard sphere model, as shown in FIG. 2, with each checkerboard “square” having a respective address. Selection of sections for editing may be performed on selected checkerboard square(s). Now in a checkerboard sphere pattern, “squares” of the pattern are not squares in shape because they are the result of the UV mapping of a checkerboard onto a sphere. Thus, a distortion is required to go from a flat pattern to a sphere pattern. As a result, “unfolding” a sphere pattern to present it on a flat display, distorts the “squares”. Conveniently, mapping an image in a checkerboard sphere pattern 80 allows for intuitive section selections in both immersive mode 80 and 81 and on a flat display.

In a variant of the present invention, the display used for immersive mode may be a projection system such as a dome or partial dome 60. In such a case, the system may still use the immersive inputs, however it may also accept input from classic input devices such as a mouse 51 and a keyboard 52. Stereoscopic perspective, where available may be achieved by using 3D glasses if the display supports 3D. The display used for immersive mode may also be adapted for a usage on a mobile device like a phone or a tablet, where the users will move inside the scene using tactile movements on the device screen, mimicking the user head movements.

The above description has been provided for the purpose of illustrating, not limiting the invention which is defined by the appended claims.

What is claimed is:

1. A system for editing immersive content comprising:
a. a tactile input device interface for receiving input from a tactile input device;
b. an immersive display interface for transmitting content to display to an immersive display;
c. a processing device in communication with the tactile input device interface and the immersive display interface; and
d. a computer readable storage medium accessible by the processing device and comprising instructions for instructing the processing device to instantiate an editing software, wherein the instructions include directives to:
i. display in real-time the immersive content in an immersive mode using the immersive display;
ii. receive input representative of a modification to be performed in real-time on the immersive content from the tactile input device; and
iii. apply the modification to the immersive content in real-time.

2. The system of claim 1, wherein the immersive content is curved-display image content.

3. The system of claim 2, wherein the immersive content is a stereoscopic curved-display image content.

4. The system of claim 2, wherein the immersive content is spherical image content.

5. The system of claim 1, wherein the immersive content is video content.

6. The system of claim 1, wherein the input is representative of a selected zone, wherein the zone is a spatial subset of the immersive content in real-time.

7. The system of claim 6, wherein the input is further representative of a modification to apply to the selected zone and wherein to apply the modification comprises applying the modification specifically to the selected zone.

8. The system of claim 1, wherein the instructions further comprise directives to introduce into the immersive content an adapted graphical user interface components for the editing software.

9. The system of claim 1, further comprising a planar display interface for transmitting in real-time content to display to a planar display in real-time, and wherein the instructions include directives to: modify the immersive content to create a planar content for a planar viewing mode and transmit the planar content to the planar display.

10. The system of claim 9, further comprising transmitting editing graphical user interface components alongside the planar content to be displayed simultaneously at the planar display.

11. A non-transitory computer-readable medium having stored thereon computer-readable instructions that, when executed by a computer, cause the computer to perform operations to instantiate an editing software, the operations comprising:
i. displaying in real-time immersive content in an immersive mode using an immersive display;
ii. receiving an input representative of a modification to be performed in real-time on the immersive content from a tactile input device; and
iii. applying the modification to the immersive content in real-time.

12. The non-transitory computer-readable medium of claim 11, wherein the immersive content is curved-display image content.

13. The system of claim 12, wherein the immersive content is a stereoscopic curved-display image content.

14. The system of claim 12, wherein the immersive content is spherical image content.

15. The system of claim 11, wherein the immersive content is video content.

16. The system of claim 11, wherein the input is representative of a selected zone, wherein the zone is a spatial subset of the immersive content in real-time.

17. The system of claim 16, wherein the input is further representative of a modification to apply to the selected zone and wherein to apply the modification comprises applying the modification specifically to the selected zone.

18. The system of claim 11, wherein the instructions further comprise directives to introduce into an immersive content an adapted graphical user interface components for the editing software.

19. The system of claim 11, further comprising a planar display interface for transmitting content in real-time to display to a planar display in real-time, and wherein the instructions include directives to: modify the immersive content to create a planar content for a planar viewing mode and transmit the planar content to the planar display.

20. The system of claim 19, further comprising transmitting editing graphical user interface components alongside the planar content to be displayed simultaneously at the planar display.
